(19) United States
(12) Patent Application Publication
(10) Pub. No.: US 2010/0292877 A1
(43) Pub. Date: Nov. 18, 2010

(54) Comprehensive engineering / operation system for electric vehicle and smart networked and decentralized power storage

(75) Inventor: Paul Zi Fang Lee, Tallahassee, FL (US)

Correspondence Address: PAUL ZI FANG LEE, 3108 SHARER RD., TALLAHASSEE, FL, 32312, US

(73) Assignees: Gabrielle W. Lee, Tallahassee, FL (US); Paul Zi Fang Lee, Tallahassee, FL (US)

(21) Appl. No.: 12/800,430

(22) Filed: May 15, 2010

Related U.S. Application Data
(60) Provisional application No. 61/216,489, filed on May 18, 2009.

(51) Int. Cl. G06F 17/00; B60K 1/00; F16F 15/30; B60R 16/04; B60S 5/06; B60L 11/00

(52) U.S. Cl. 701/21; 180/65.1; 74/572.1; 180/68.5; 701/22

(57) ABSTRACT

Comprehensive, Systematic and Practical Engineering/Manufacture/Operation/Management System for Electric Vehicle with dual usage for Decentralized Smart Power Storage that includes: Smart Battery Subsystem (SBS), which includes the Smart Battery Assembly (SBA) with embedded computer/data logger and the Battery Compartment (BC) on the EV and in the Swapping Recharge Stations (RS); the computers on the EV and RS; hardware and software for the SBA Exchange/Recharge/Maintenance/Management/Billing Subsystem; the Smart Decentralized Energy Storage Subsystem for on-line, off-line and/or emergency uses. The SBA can be swapped at RS or recharged at home or any recharge stations, or dismounted/mounted easily in garage or during roadside service. The SBA could include the built-in charge controller and inverter. All the subsystems are indispensable parts or options for this invented integrated system.

### CROSS-REFERENCE TO RELATED APPLICATIONS

This application claims the benefit of the filing date of U.S. Provisional Patent Application No. 61/216,489, filed May 18, 2009. The entire disclosure is that application is hereby expressly incorporated by reference herein.

### BACKGROUND

1. Field of the Invention

The Electric Vehicles (EVs) have been widely utilized ever since the electric motor and the storage battery were invented and commercialized. These include golf carts and forklifts; electric buses running on the overhead electric supply cables and tram cars rolling on narrow rails; also the final electric motor propulsion is used in the diesel-electric locomotives, submarines and cruise ships. EVs are recognized for its low on-site emission of pollution, low noise, high efficiency, simple mechanical structure and the built-in regeneration ability to collect the inertia energy of a moving vehicle back to recharge the battery during deceleration and braking process. However, the electrically powered vehicles have never been widely accepted by the general public as a privately owned, free running vehicle for commuting, albeit for long distance travel.

EVs have never been thought feasible in applications for long distance buses, trucks, agricultural tractors or harvesters, heavy construction machineries, military vehicles, nor for boats and ships, except in submarines and in the most recently developed cruise ships and experimental military ships. However, we should notice that the primary energy source to provide electricity in some of these electric propulsion locomotives, submarines and ships range from diesel, gas turbine to nuclear powered steam turbine; and the storage batteries on these vehicles are only used for interim energy storage means.

In conventional electric networks, electric loads change by time within the 24 hour of a day and season, while the electric generation system is limited by its top capacity and changeability. That mismatch of production versus consumption lowers the efficiency of a power supply-consumption system, also forces the overdesign of the generation system to ensure the safety of the system. Distributed Smart Electricity Power Storage could improve the such irregular mismatch. Another difficulty for incorporating the alternative, distributed energy production systems (such as residential and institutional roof top solar or wind power generation systems) to supply power either to the on site self sustaining usage or to be connected online to the main network also need relatively large capacity electric storage devices. For example, the solar power could be plentiful during a sunny day, but the residential uses often have a peak demand in the early evening. Although many electric generation plants allow the reverse feed of power from the consumers to the network, the time distribution and discrepancy among the main network generation, the decentralized power generation and the power loads need a smart power storage system of a significant total capacity that is comparable to a fraction of the total loads. This invented system could significantly assist the realization of such a smart accessory power storage system.

2. Descriptions of Related Art

The recent efforts to promote the EVs are motivated by the limited availability and ever increasing price of fossil liquid fuel resources, foreign energy dependence and high emission of carbon dioxide and other pollutants associated with the Internal Combustion Engine Powered Vehicles (ICVs). The visible results of such efforts include the electric scooters/bikes, electric cars and hybrid cars. These vehicles, except the bikes, are designed following the current model of internal combustion engine powered vehicles (ICV) in terms of size, configuration, look, speed, travel distance, price range, human comfort, etc. especially of the passenger cars including pickups and SUVs (sports utility vehicles).

Also we should notice that the primary source of energy to generate electricity in the hybrid cars are still the fossil fueled internal combustion engine; the storage batteries are used for the storage of the recaptured engine idling energy and regeneration energy.

Although plug-in hybrid is about to show up on the market, but the battery still may provide smaller portion of the total energy used in hybrid cars.

Some pure electric cars have been manufactured with various combination of rechargeable batteries and electric motors with provision of plug-in recharge at home, at work place, at pay and charge stations or at lodges. The maximum travel range of these electric cars were around 300 miles and the recharge time usually is in the range of several hours, with exception of some optional accelerated recharge time of around or less than one hour, but with penalty of shortened battery life.

Comments on the recent announcement and demonstration of a battery swap station design by Better Place on May 13, 2009 Battery exchange/swap and standardization started as early as when battery was first available commercially. From flashlights to toys, from cordless tools to cordless phones, from cell phones to digital watches, when the battery is depleted, we swap a new battery or a recharged one to continue their function and operation. Therefore the battery swap and standardization ideas are not patentable. The patentable items in our design are different configurations of how these well known technologies, parts and devices are organized and working effectively together. Electric car battery swap system/stations had been experimented many years ago in Hong Kong and recently in Beijing's 2008 Olympics, Switzerland and Israel. There are more spaces to compete in this field.

Better Place (A Company Name) demonstrated an electric car battery swap station design on May 13, 2009. The battery of the electric car releases from the bottom of the car to an underground level railed carriage. A fully charged battery will then be inserted from the lower level carriage to the car. This system obviously attempts to achieve similar objectives as our proposed system. However, there are some basic differences. The two level operation system at the battery recharge/exchange station enables the electric car to pull through the station. The bottom exchange route may provide more flexibility for the car stylists.

The disadvantages of the bottom battery exchange design:
a. The fundamental disadvantage of a bottom battery exchange operation system is that the EV can only be served at the specially constructed and equipped stations.
b. One underground rail can only serve one car at a time. For serving multiple cars at the same time, a multiple lower level rails patterned to intercept the above ground drive ways will be needed and the battery transportation system will become very complicated. (Our design proposes that the battery package be released and inserted through the front, the back or the sides of the vehicle.)
c. The bottom release/insertion battery exchange system eliminates the possibility of home garage battery exchange, nor road side emergency battery exchange. In our design, the only tool needed for manual battery exchange is a pair of foldable wheeled carriages of matching geometry with the battery package, with built on rails/rollers.
d. The bottom battery exchange configuration eliminates the possibility to use second battery for home garage recharge /exchange.
e. The bottom battery exchange configuration eliminates the possibility to use as a second EV battery recharged by a decentralized electric power supply (roof top solar panels, wind generator or small hydroelectric generator).
f. The dual usage for functioning as part of the smart network on- or off-line connectability nor provision for emergency supply nor the possibility to manually swap it with a depleted battery in a convenient manner in a short time has never been intended or reported related to the Better Place system.

Is Battery the Key Technology in Promoting EV? With our habitual thinking, we expect an EV with very similar specifications of an ICV, i.e., size, weight, payload, cruise range, speed, acceleration, look, and drive feeling, etc. With such a model in mind, the recent research and development are focused on how to manufacture a storage battery of high energy density, light weighted, safe, inexpensive, with short recharge cycle and maximized number of charge-recharge cycles/long life expectancy, that with such a battery the EV will be comparable to an ICV with a tankful of gasoline.

Some designers consider seriously that the EV (and/or hybrid cars) should be able to be recharged overnight at home, at the office parking lot or at the hotel parking lot.

Then, if this idealized EV with the idealized battery is already a reality, can we use it in just the same way as we use our ICV?

The answer is NO. Then, Why?

The public's major concern is the cruise range of an EV. So the engineers and companies try very hard to make a battery that can supply power for a EV to reach the similar cruise range of an ICV, i.e., a maximum travel distance of around 300-400 miles or a travel time of around 5 hours on major highways with an average speed of 60-70 mph on a fully charged battery on the EV, just as an ICV with a full tank of fuel.

The main operational difference between an ICV and an idealized EV can be illustrated in their common operation scenarios (Table 1).

TABLE 1
Operation Scenarios

| | | | | Overnight stay | |
|---|---|---|---|---|---|
| | | same day return to home base | | EV w lodge | EV w/o lodge |
| | | ICV | EV | recharge | recharge |
| In-town round trip, <5 hr. total | | Yes | Yes | | |
| Oneway □-2.5 hrs | Oneway | Yes | Yes | Yes | Yes |
| | Round Trip | Yes | Yes | Yes | Yes |
| Oneway 2.5-5 hrs. | Oneway | Yes | Yes | Yes | Yes |
| | Round Trip | Yes | No | Yes | No |
| Oneway >5 hrs | Oneway | Yes | No | No | No |
| | Round Trip | Yes | No | No | No |

This table covers the most common scenarios of using a car, for daily commuting, for out of town business, for vacation, up to for cross country travels. There will be obvious limitations to use the currently available EV as shown in the table. In rare cases, when we got back home after work and the EV battery is empty, one may find that a member in the family needs to go to the hospital, or we have an evening party to go. The EV will be certainly to blame, if it fails to provide such services.

Evidently, we will not accept a ‘minimum of two-vehicle per family system’—one EV for commuting and in-town travel; and another ICV for long distance travel.

The following Table 2 shows the comparable performance features between a compact grade ICV and an idealized EV with an ideal battery.

TABLE 2

| | EV w/ideal battery | | ICV | |
|---|---|---|---|---|
| Travel Range | 300 | miles | 300 | miles |
| Peak Motor HP | 50-75 | HP | 150 | HP |
| Cruising HP | 60 | HP | 70 | HP |
| Battery Voltage | 120 | V | 12 | V |
| Discharge Amperage | 60 × 750/120 = 375 A | | | |
| @cruising speed | | | | |
| w/motor of 100% | | | | |
| efficiency | | | | |
| Top Speed (practical) | 80 | mph | 80 | mph |

| Energy Loss during | 20% or more | 0 | |
|---|---|---|---|
| Refuel | | | |
| Refuel Hazards | heat, gas, fume, chemical | minimal | |
| | spill, fire, explosion | | |
| Recharge/Refuel Time | 5-10 hr. @>400 A to 200 A | 5 | minutes |
| | @110 V | | |

| | | |
|---|---|---|
| Recharge/Refueling | Home garage, fleet and parking | interantional |
| Facilities Metering | lot recharge system in proposal | available |
| & Billing systems | | |

Driving an ICV, we may stop at a gas station and spend around 5-10 minutes to fill in a tank with 16 gallons or more gasoline. However, if the ideal battery can support an EV driven by a 60 HP motor of 110V for 5 hours, the discharge rate will be >375 amperes. Assuming that the discharge and recharge all have 100% efficiency, to fully recharge the same battery, the recharge current will be at least 375 ampere at 110V for 5 hours. That means to accommodate a plug in EV the conventional 200 amp home supply system capacity has to be at least doubled, so will be all the electric distribution and transmission systems. Further, if we try to reduce the recharge time to be comparable to the refuel time of, e.g., 10 minutes for a ICV, or 30 times shorter than the discharge time, the recharge should have to be conducted at least 11,250 Amp at 110V. In other words, it will be on an energy rate of 1,237 kW. Such high density of recharge energy rate is obviously not feasible and very dangerous.

After the afternoon commuting time when people come back home from work, they turn on the air-conditioner/heater, plug in the EV to the home base recharge system, turn on the TV or computer and start to cook their dinner. To depend on home site overnight recharge from the main power network means creating a peak loading to the electric supply network when such EVs are widely used.

Table 1 and 2 demonstrated that with similar performance and specs, the ideal EV still has some unacceptable shortcomings in some operation scenarios for people who are used to their ICV. Unless . . .

Unless We Separate the Batteries from the EV

During and after WW II, System Engineering or System Design has unveiled a new vision, new concept and new method in solving problems in a complex system. Instead of analyzing, designing, and improving an individual device in such a system, one has to start with analyzing all factors and all aspects in the entire system. To certain extent, the larger the system under consideration, the better could be the problem solving results—based on the reality and design objectives, often include human factors.

A transportation system may include many subsystems, namely, the driver/passengers, the vehicle, the manufacturer—dealership subsystem, the fuel supply subsystem, the highway subsystem, the safety subsystem, the traffic control subsystem, the financial subsystem, the insurance subsystem, the service subsystem, the residential, business and roadside parking facilities, even the Rest Areas on the Interstate Highway . . . etc.

From the above mentioned table of the usage scenarios, we found that an idealized battery does not enable the EV to be adopted as a general personal/family transport; and that the major obstacle impeding the commercialization of EV is that its recharge subsystem has a fundamental conflict with our demand on its application performance.

The way to overcome the obstacle is to separate the EV from its battery. It sounds weird. Yet it could be the best way, or perhaps the only way. We are used to fill in gasoline to a tank in our car. Our mind is set by such habitual model of thinking, that the energy is being transferred from the gas station to the tank of our ICV; therefore, we should recharge our EV with electricity supply to the storage battery in our EV in a similar way. This is a big mistake to analogize the two very different systems. The stored energy in a gas tank and in a storage battery may be in the same order of magnitude, but the refuel/recharge rates of the two systems are very different physical processes at very different energy density levels.

The fundamental reason these two kinds of vehicles are not comparable is that the refueling in ICV is a pure physical process of moving a liquid from one container to another, and that the recharging a battery is a physical chemical process which proceeds electron by electron. The former does not involve significant material status change nor energy loss, therefore no significant heat is produced during refueling at the gas station. The latter involves electro-chemical reactions, the rate of which is limited by both the system dissipation capacity of the waste heat, gas and fume; also limited by the electric current capacity of the cable, the switches, the connectors, the controllers, the rectifiers, etc.

### SUMMARY OF THE INVENTION

This invention is about a new integrated EV system that includes several subsystems. One of the most important subsystems is its Smart Battery Subsystem (SBS) FIG. 1, FIG. 2, FIG. 3, FIG. 4, that shall include the Smart Battery Assembly (SBA) FIG. 1, FIG. 2—the energy capsule; the Battery Compartment (BC) FIG. 2, FIG. 4, FIG. 5, FIG. 6 on the EV and in the Recharge Stations (RS) FIG. 7; the computer/data logger on the EV and RS; the embedded computer/data logger within the SBA; the Recharge/Maintenance stations; and the Metering-Billing subsystem.

The SBA in such a system shall be manufactured according to a standardized modular geometry and configuration. This should include, but not limited to the exterior geometry, the physical strength of the assembly, the position and geometry of the connectors 7, 8, the voltage of the main battery, the data logger based on the embedded microprocessor with its integrated memories and the protocol/software of communication, the built-in cooling 10 subsystem, etc. The SBA is an electro-microprocessor-mechanical entity that is also mechanically and electronically hardened for preventing from tampering FIG. 1. The SBS works in the following way: The SBA is engineeringed and manufactured to be easily inserted into or removed from a BC on an EV FIG. 1A. The compartment shall be engineeringed and constructed to be easily accessible from the front for some vehicles, or the back, or the sides of some other EVs through an automated electro-mechanically lockable door 22, 23, 102, 104 with or without an integrated powered or non powered rail/roller and locking/latch mechanism 21, 24, 25, 26 to assure that the battery could be easily inserted into or retrieved from the compartment and to keep it in a secured stable position, with secured electric and electronic connections in the moving EV FIG. 1A, FIG. 2, FIG. 3, FIG. 4, FIG. 5, FIG. 6 and during a traffic accident. The insertion, rail and locking mechanism shall also assure the correct and dependable electrical connection of the main power connectors and the data communication connectors between the SBA and the EV, even in adverse weather and road conditions.

The SBA may be constructed with a ‘handle’ or mechanical handling notches 3, 11, 13 that can be manually held and/or automatically hooked and locked onto a robotic system that is used in an automated recharge/maintenance station or home garage to retrieve, to insert and to manipulate the SBA FIG. 1A, FIG. 8, FIG. 9, FIG. 10.

An EV proposed by the invention pulls into a roadside recharge station shall stop and park in a marked space within certain position tolerance FIG. 1A. The Station either equipped with wireless (including optical) communication quest/responder and/or bar code reader that recognize the ID and current membership of the incoming EV. The handshake protocol includes the positive eligibility signals exchanged between the station and the EV including a password sent by the driver. The completion of the protocol will allow the opening of the BC controlled by the driver so to start the battery exchange routine. A robotic carriage/arm/ramp from the docking site of the station will aim itself relative to the position and orientation of the EV, then it may hook on the battery handle, or the SBA could be driven by a group of powered rollers to deliver the battery from the BC in the EV and transported on a digital conveyer system in the station. A fully recharged battery SBA then will be inserted to the BC of the EV FIG. 1A. The SBA will be locked into position in the EV and the door of BC closed much like the door on a VCR when a new video tape has been inserted. The computer in the SBA will communicate with the computer in the EV. The EV computer will record and display the universal ID of the SBA, the time/date of the transaction, the name/ID/address of the station, the technical electric condition and quality of the SBA, the variety of the battery, etc. The computer in the SBA will also record the ID and other info of the EV, the time/date of the transaction, the station info, and check the quality of the SBA, etc. The station computer will log the info and data about the relevant EV, the SBAs and the interaction communication.

After a few seconds the EV will be given a pass signal and the EV will leave the station. The entire exchange of SBA may take less than 10 minutes. The station could be partly or fully automated and/or unmanned for the battery exchange action. The used SBA then will be transferred and stacked into the recharge array with manual or automatic transportation vehicle. The recharge/storage rack has multiple standardized compartments FIG. 7 with same standardized rail, locking and electric and electronic connectors as in the EV. The recharge system will record the IDs of the SBAs being exchanged and the EV, which delivered the used SBA to the station, the variety, the history and the conditions of the SBA, etc. The station computer will use such data to choose the most appropriate recharge procedure for the battery. The history of the SBA will be used for billing purpose; also for the decision of time of replacement and format of recycling of old or defective SBAs.

In the entire system, the ‘System Management’ will manage and franchise hundreds and thousands of recharge stations in all the cities and along the highways. Each station may store hundreds of SBAs in their automated rack under different stages of recharge and maintenance. Nominally, each EV owns at least one SBA, but not necessarily a fixed specific SBA. A newly purchased EV will join the system when its new SBA joins the circulation of all the SBAs, as part of the membership due. The System should guarantee the minimum capacity of a ‘fully recharged SBA’ for all its member customers receiving such a grade of SBA. A monthly bill will be sent to each of the customers, just like the other credit card system. Unpaid bills will be corrected/managed with a grace time, warning, penalty and suspension process. In short, the ownership of the battery collection belongs to the system not to the individual vehicle/vehicle owner.

The EV will have a recharge system of its own, that recharge can be conducted leisurely at the plug-in station of the family garage, fleet garage, parking space at the office of hotel, or by the car top solar panel, decentralized power generation systems, etc. when the recharge time is not critical or the battery is not totally depleted between uses of the EV.

The EV has another Accessory Battery (AB) of its own, for its own computers and household maintenance that is separate from and much smaller than the main propulsion battery SBA. The AB will be recharged automatically by the main power battery, or by solar panels, or by plug in to the main electric network, etc. The AB will supply all the internal electric power needs such as the onboard computer, lights, power lock/door/window/seat/security, battery compartment door and SBA moving motor, etc. despite whether the SBA is onboard or not. The AB may provide emergency moving power for the EV to travel 10 miles or so, in case the main SBA fails.

The system allows different kinds of storage battery technologies, from lead-acid to lithium-ion, from ultracapcitor to fuel-cell, from flywheel battery to hybrid self-recharge battery, . . . to coexist as far as certain standardized specs are followed. The customer in the EV can choose, as an example, the ‘Standard’ grade, the ‘Plus’ grade or the ‘Premium’ grade SBA to be inserted. The different batteries will have different Ampere-hour capacity, different maximum discharge rate, etc., although their voltage must be standardized and compatible. So the customers can choose based on their needs, the value versus the price of these different grades of SBA. These choices will be reflected on the bill. Trucks, vans, buses, RVs, construction and agricultural machineries, etc. could be equipped with multiple standardized BCs to install multiple SBAs, to fulfill their different duty cycles.

The electric motorcycles and electric scooters can be served by a similar miniaturized standardized battery/recharge/billing system.

### BRIEF DESCRIPTION OF THE DRAWINGS

These and other features of the present invention, and the attendant advantages will be readily apparent to those having ordinary skill in the art, and the invention will be more easily understood from the following detailed description of the preferred embodiments of the present invention, taken in conjunction with the accompanying drawings, wherein like reference characters represent like parts throughout the several views and wherein:

FIG. 1A is a substantially schematic presentation of a typical service port at a RS that is serving an EV for SBA exchange.

FIG. 1 is a substantially schematic presentation of an orthographic drawing of a SBA.

FIG. 2 is a substantially schematic presentation of a SBA inserted in among the rollers, the padding and the locking door of the BC. The BC case is not shown.

FIG. 3 is a substantially schematic presentation of a SBA in perspective view.

FIG. 4 is a substantially schematic presentation of a BC showing the positions of the rollers, the pad, the locking door with electric and electronic connectors and the door activating and locking actuator.

FIG. 5 is a substantially schematic presentation of a BC with the door open upward.

FIG. 6 is a substantially schematic presentation of a BC with the door still open and a SBA inserted but not yet to the seating position.

FIG. 7 is a substantially schematic presentation of a BC array in vertical stacking situation, in fact the array could be in two-, or three-dimension.

FIG. 8 is a substantially schematic presentation of a manual forklift for transporting the SBA between the EV and the SBA storage/recharge BC array in a RS. The bar code readers 41 shall send visual or audio signals to help the driver to recognize and approach the address of the computer designated BC in an array either for restock a SBA or to retrieve a SBA.

FIG. 9 is a substantially schematic presentation of a semiautomatic forklift with SBA hook up and handling mechanism for a low cost beginner's RS.

FIG. 10 is a substantially schematic presentation of a semiautomatic forklift with sideway SBA hookup and delivery mechanism.

FIG. 11 is a substantially schematic presentation of a semiautomatic forklift with sideway SBA hookup and delivery mechanism and storage chambers to pre-store a multitude of outgoing, fully charged SBAs to save trip between the service port of the RS to the BC array storage area.

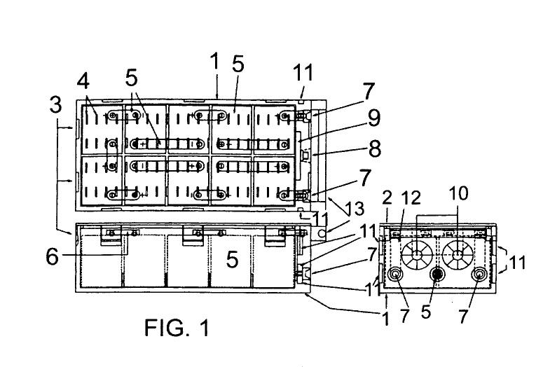

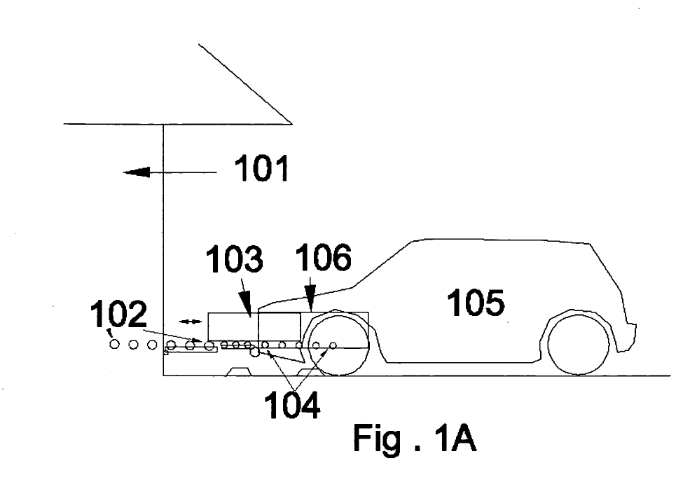

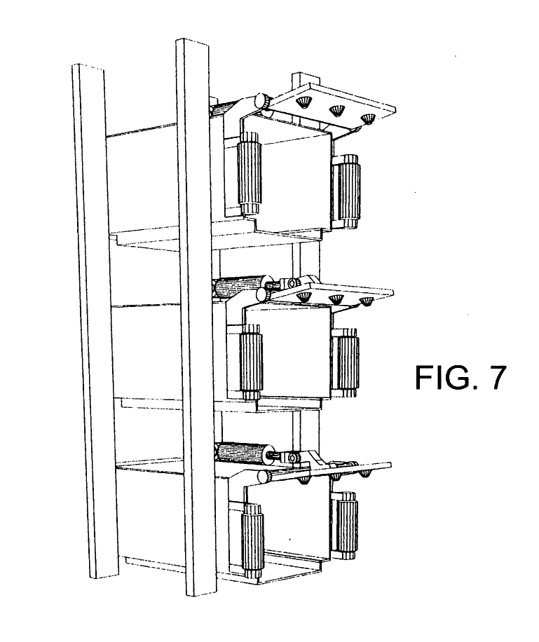

Numerical notation keys for FIG. 1A, and FIG. 1-11: 101. RS housing, 102, movable ramp with rollers at the service port aiming to the EV's SBA door, 103. SBA moving between EV and RS, 104. rollers in the BC of the EV and at the SBA door of EV, 105, the EV under service, 106. the BC in EV. 1. Outer case of SBA, 2. top lid, 3. locking latches, 4. ventilation slots, 5. individual batteries, 6. serial connection bars between batteries, 7. main power connectors (one positive, one negative), 8. data-logger communication port, 9. embedded, sealed and tamper-proof data-logger/microprocessor, 10. cooling fans/exhausts, 11. positioning notches, 12. conducting bars from batteries to the main power connectors, 13. handle bar, 21. back bracket/cushion, 22. side rollers in the battery compartment (BC), 23. bottom rollers (powered or non powered) in the BC, 24. BC door actuator. 25. door hinges, 26. BC door, either on the upper side or on the lower side of the BC, 27. Cone shaped main power connectors with self aligning character, cables are not shown, 28. multi-terminal communication port connector, cable not shown 41. rack address scanners, 42. rack slot final precision alignment scanner, 43. SBA puch/pull plate and hook, 44. hooks, 45. push pull ball screw support bearing, 46. push pull screw actuator and positioner (similar to ball screw in CNC machines), 47. vertical actuator for the hook up and down movement, 48. rollers, 49. stepping motor to precisely control the push and pull movement, 51. driver seat, 52. steering wheel, 53. SBA carrier movement controls, 54. instrument, command and position display screen, 55. instrument, command and position display screen, 56. delivery/pickup alignment precision control scanner, 57. SBA hooks, 58. SBA position adjustment and on board storage actuator, 59. push pull plate (similar to 43), 60. SBA carrying deck, with ball rollers for 2 dimensional movement, 62. on-board storage bins, 63. carriage vertical travel track, 66. steering wheel of forklift, 70. ballscrew end bearing (same as 45.)

### DETAILED DESCRIPTION OF THE PREFERRED EMBODIMENTS

1. The cruise range of an EV becomes unlimited, just like the ICV, as far as the recharge/gas station network reaches. Only such system will make the EV acceptable by the public. By then, the ECVs and EVs will coexist, compete and become true choice for the public. The existing gas stations can opt to join the EV recharge network using their existing location, the real estate and personnel after some modification of the station and staff training.
2. Energy regeneration is a built-in, inherent property of modern electric vehicles that uses the kinetic energy of the moving vehicle during the deceleration and braking to recharge the battery. Such energy would have been wasted as heat when there is no regeneration function.
3. Although it should be a nonexclusive option to recharge the EV overnight at residential sites, office or hotel parking lots, it is not necessary to complicate the house, the apartment, the hotel and the office parking lot with recharge plug-in facilities, which must include metering and billing systems. Such an overnight or daytime recharge system also needs extra heavy duty connection to the electric supply network, safety provisions and special training to the driver/owner.
4. The potential hazards (electrical, chemical and fire hazards) associated with high voltage, high current recharge process and mishandling of batteries will be minimized or eliminated. The hassles to check the electrolyte level, density and other technical details and recharge pattern will be handled by either expert service personnel and/or automated system, since each SBA carries its own ID including what kind of battery technology it is constructed, and usage history.
5. With the battery exchange/recharge station network in place, EVs refueling by exchanging the SBA will take about 5 minutes or less, without even the driver leaving the vehicle. An automatic battery exchange station can provide 24 hour service with no sales/service attendant. Labor, the most expensive cost for any commercial system is saved.
6. The demand for the maximum cruise range of an EV with a single fully charged battery pack could be reduced from 400 miles to around 200 miles, if the area recharge/Exchange infrastructure has been in place. For an average driver on the highway, a short break after 3 hours driving will be quite reasonable, provided an average speed of 60-70 mph, which means a cruise range of around 200 miles. The EV driver can turn to an exchange station, pull to a designated position, and push the selection button of the battery grade. The rest of the operation for exchange of the SBA, the metering of how much energy is used from the old battery, the ID of the SBA and the EV, etc. will be exchanged between the EV computer, the battery data logger, and the station computer, the entire process will start and finish automatically.
7. The reduced requirement of battery's minimum unit capacity shall allow the EV more design flexibility, with more choices of variety of batteries, with less weight and size of the EV structure, i.e., for the same amount of energy, it will sustain relatively longer cruise range and better acceleration, etc. That means a more energy efficient system overall.
8. The driver of EV within the territorial coverage of the recharge/exchange station network will always have a fully recharged and well maintained SBA waiting for exchange, whether driving in a city or on a long stretch of highway. No more anxiety and uncertainty of an old or depleted battery and the difficult decision on when to purchase an expensive new battery. New batteries and new tech batteries will be replacing the old ones and replenishing the system based on strict technical criteria. The expense of the entire system will be sustained by all the customers and members of the system. The cost to the EV consumers will be proportional to the actual electricity used and the grade of the battery they choose to use.
9. The separation of EV with the battery will allow competition of different storage batter technologies that will include all kinds of chemical batteries, flywheel battery, ultracapacitor battery, hybrid battery and other technologies. Even the old lead-acid battery can be used in such a system.
10. The recharging electricity load will be more evenly distributed and managed, since the recharge for all the batteries are ongoing throughout 24/7 in the stations, there will be no sharp peak loading on the utility system. The electric connection/transmission to the limited number of the recharge stations (compared to the number of residential houses) will be concentrated and much less expensive compared with if all the residential houses should be re-wired and re-metered to a high capacity electric supply system exceeding the commonly accepted 200 ampere per house. Further, the cluster of SBAs in the stations can function as part of the smart energy storage depository to smooth the fluctuation discrepancy between the power generation and power consumption in time, and also during an emergency.
11. For long hop of trip or for performance enhancement, premium grade battery can be selected by the user.
12. Heavy duty/long distance vehicles such as trucks, buses, vans, agricultural tractors, construction machines, forklifts, material moving vehicles, military and mining vehicles and equipments can be electrified by using the standardized SBS with multiple battery compartments on board and the same recharge/exchange station network facilities.
13. The proposed system will be responsible for guarantee the minimum performance criteria on any delivered SBA of a given grade. The most confusing, painful and difficult decision on when to replace an aged battery in an EV becomes the responsibility of the management of the system and should be technically and legally enforceable. The decision to discard a SBA will be based on the technical performance and usage/recharge history of the SBA, not on subjective personal judgment or based on the temporary business financial interest.
14. The business/innovation/research opportunity created by the wide acceptance of this system will benefit the car makers, the battery makers, the computer makers, the gas/recharge stations, the utilities, the financial institutions (credit card businesses), the electronic recharge system makers, the communication businesses, the environment, and finally the general public.
15. New jobs will be created following the expansion of the EV system.
16. The general public will enjoy the EVs as much as they are used to enjoy their private ICVs, yet with less noise and less air pollutant emission.
17. The EV system with separate battery will be feasible and benefit any scale of application, from a small fleet as well as to a nation. The system can be tested to serve a small city's police motorcade, for example, with 100 police vehicles and 400 SBA. With a full recharge time of 8 hours for each battery package, the system can keep all the vehicles on the street at any time for as long as needed, with plentiful of reservation. Similar scenarios can be found in many other businesses, such as the post office, the city buses, the waste management garbage collection trucks, etc. It is very easy and natural to start testing on small fleets, then connect these systems and promote the standardized system to the personal vehicles, then connect the entire country.
18. This EV system will allow competition and cooperation, and it is not designed to monopolize. Subsystems and subnetworks can be owned by different entities, while allowing cross business territory boundary services, much like that the standardizations of the AC voltage, frequency, plugs and sockets, of the household electric service have been enabling and encouraging the booming and competition of appliance industries. Some major industries/businesses should cooperate, compete, flourish, progress and benefit from the proposed EV system.
19. EVs engineering following the principles offered by this invented system will be safer. There are three main reasons: a. The center of gravity of the EV will be very low and the weight distribution can be made symmetrical and balanced. b. The EVs will be relatively lighter in weight and smaller in size. Once the majority of the vehicles on the street and highway become lighter and smaller, the inertia energy released during a collision will be relatively reduced. The seriousness of collision will be reduced, too. c. The fire and explosion potential of liquid fuels during a traffic accident will be greatly reduced, when EVs become the majority in traffic.
20. EVs following the engineering principles proposed by this invented system will be very easy to configure among two wheel drive, all wheel drive or 4 wheel drive. The individual wheels can be direct-driven by individual variable frequency Permanent Magnet Synchronous Motors controlled by IGBTs or the likes. The mechanical gear or belt transmission system may be simplified, reduced or eliminated. The couplings between the wheels will, as an option, depend on the electronic/computer control system in replacement of mechanical gear system including the mechanical transmission for engine speed/wheel speed ratio change, the differential gear box between the left and right side wheels and the differential gear box between the front and rear wheels.
21. The simplified mechanical system will further reduce the cost, the weight, the size, the production cycle time of the vehicle. It will reduce the maintenance and repair frequency, requirements and complexity. In addition, it will simplify the, recycling of all parts and materials that construct the entire vehicle.
22. The large capacity standardized smart battery assembly (SBA) can also be used for general energy storage purpose. An EV fleet owner or any individual EV owner may purchase extra SBA that can be recharged by wind generator when the wind is available or by the solar panel during the day time, or recharged at home garage by the public power supply net and discharge back to the net when needed (smart storage). These SBAs can be used for either exchanging with a depleted SBA in an EV, or to be used with a built-in or exterior DC-AC converter to supply for household use during a blackout of the main electric supply due to natural or man-made emergency, or for totally energy-independent household when the wind dies off (for wind system) or after the sunset (for solar system), or serving as buffering storage for the entire network. Up to now, the decentralized residential or business wind/solar power supply system depends on feeding back the generated electricity through a synchronized DC-AC converter back to the network, provided that the local utilities encourage and credit such backfeed energy. For an independent wind powered or solar powered home, power storage for usage after wind dies off or after sunset, has been a major challenge and an obstacle in promoting the decentralized power system. The owner recharge system may or may not be as fully automated as in a station, however, the design of the SBA allows easy retrieval and reinstallation through the rail/roller system in the BC on the vehicle and in the garage. Also, the owner recharge system with a redundant SBA will save money; further, the recharge system gets the electricity from the household power supply from the public power network during the low load time. The slow recharging rate of such system will not cause evening time surge of electricity consumption or need to rewire the existing distribution system.
23. The onboard or the garage recharge system can be and should be designed as a two-way inverter, that means, it can control the recharge to the battery from a AC power source or other DC power sources, also can function as a synchronized DC to AC inverter to feedback energy either to the public electric supply net or to the household terminals. The selection of these functions should be controlled through the onboard computer with interlocking logic that should assure the safety and match among all the electric specifications, connectivities among different systems and functionalities when any of these function modes are selected by the user.
24. Among all the renewable/alternative energy sources, the production and consumption of liquid biofuel to replace fossil fuels for internal combustion vehicular propulsion will not significantly improve the carbon dioxide balance in the atmosphere, simply because the transportation energy source is difficult to change. If the nuclear, solar and wind generated electricity can be used to recharge EVs in large scale, the carbon dioxide in the atmosphere will be significantly reduced. In addition, according to some studies (studies conducted at University of California, Berkeley and University of Cornell), the liquid fuel consumed directly for cultivating, irrigating, fertilizing, harvesting, transporting, fermentation and distillation for the production of the biofuel may be equivalent or exceeding the amount of liquid biofuel thus produced. This is another reason to promote EV.
25. The Overall Explanatory of the EV system: In FIG. 1A, an EV parks in front of one of the battery exchange slot of a Battery Exchange/Recharge Station, which is furnished with an array of these battery exchange slots. The laser scanning system of the station will scan a holographic bar code on the vehicle, or the wireless radio signal of quest-responder will have to recognize that this is a legitimate member of the system and its unique ID. Once the first recognition handshake ceremony is over, the door on the station and on the EV will open to let the Smart Battery Assembly (SBA) pushed and rolled halfway out from the Battery Chamber (BC) of the EV. The roller platform from the station extends out to match the height and orientation of the vehicle door to receive the SBA. Optical, tactile and/or magnetic sensors can be used with the special positioning reflectors or objects on the vehicle to allow the positioning adjustment of the station ramp manually, semi-automatically or automatically accomplished.

After the used SBA was accepted to the station, it will be manually, semiautomatically or automatically inserted onto a standardized recharge/maintenance chamber of a 3D storage/recharge array system inside the station. In the meantime, a fully recharged SBA will be moved to the position to be manually, semiautomatically or automatically inserted into the vehicle.

After the SBA reaches the seated position in the BC of the vehicle and all electric and electronic connectors are engaged, an automatic check and trouble shooting routine will be proceeded by the vehicle computer to scan all the electric, electronic and microprocessor functions in the SBA. If all passed, the EV driver will get a final confirmation signal on the dashboard and to the station, then the BC door will be closed and the EV is ready to leave the station. If the newly installed SBA can not satisfy the function check, the vehicle computer will send a signal to the station and ask for another SBA to be installed and the exchange procedure will restart. This routine quality check is necessary to ensure that the installed SBA works as specified.

As mentioned in previous chapters, the ID of the vehicle, the ID of the SBA, the ID of the station, the condition of the SBA and the date/time stamp will be stored in the SBA as well as in the EV and in the station together with all corresponding steps of the SBA exchange/recharge/maintenance processes and computer operations. All the stored data can be transferred through the plug in connections or wirelessly among the battery, the station, the EV or downloaded to a notebook PC of the owner, or printed by the printers at the station or in the EV. All the communications should be protected by a security system that only the targeted receivers will get the information.

Similar technical checkout, ID check and bookkeeping on the newly arrived depleted SBA will proceed immediately in the station. As mentioned in previous chapters, the recharge and maintenance will follow the optimized scheme based on the battery technology, battery condition, battery history, etc.

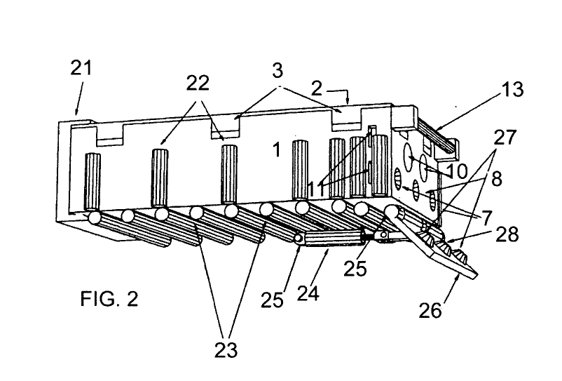

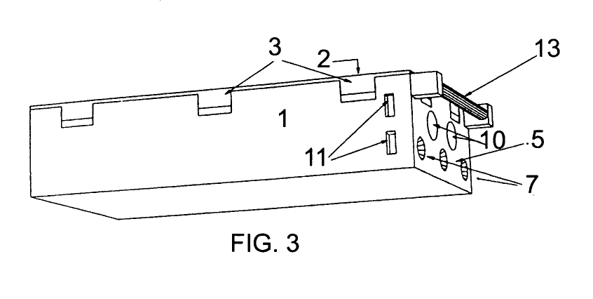

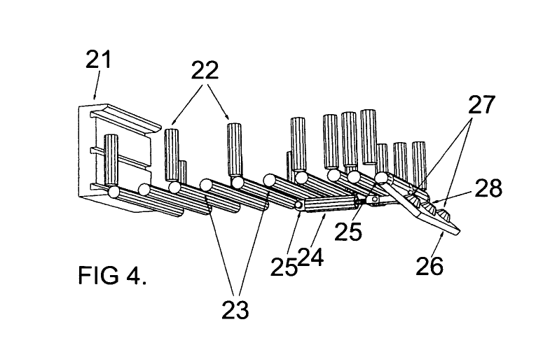

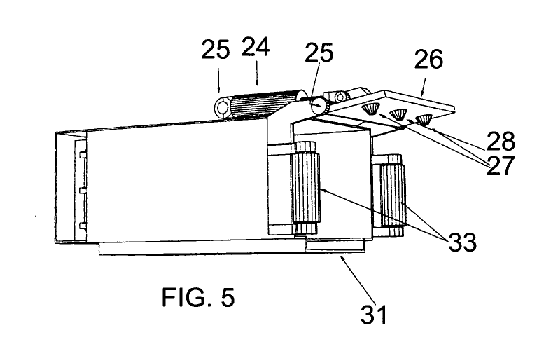

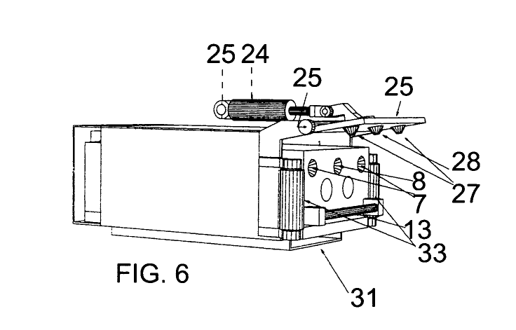

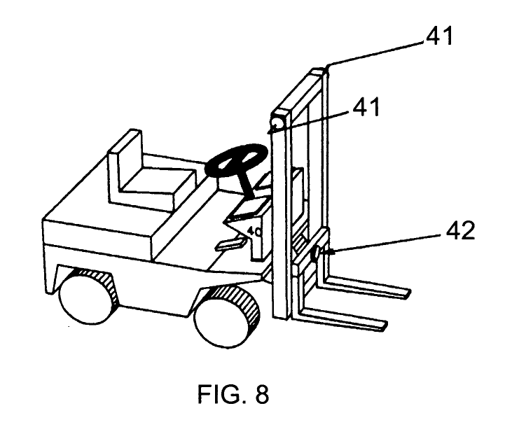

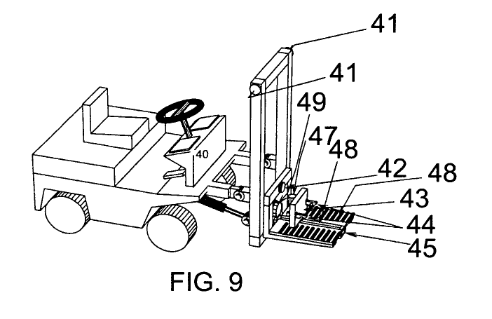

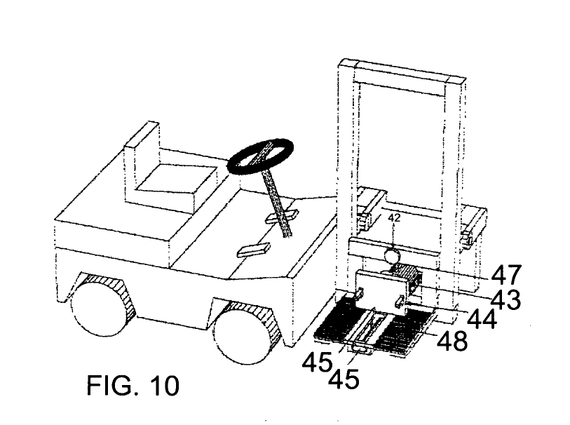

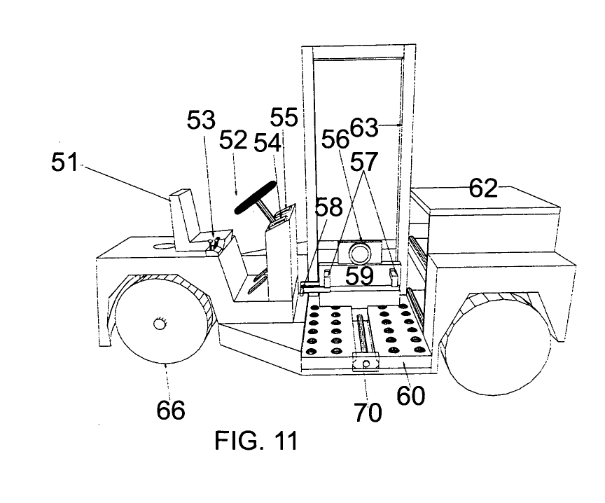

Based on the usage history recorded on the data-logger/computer of the SBA and other factors, such as the grade of the SBA, a financial charge will be electronically added onto the vehicle owner's account. The owner shall receive a monthly report and bill, just like a credit card billing system.
26. Proposed embodiment of SBS (Smart Battery System) and BC (Battery Compartment)
   A rectangular shaped battery has multiple battery units in serial/parallel connections to match the standardized voltage of the system FIG. 1. There is a buried, tamper-proof microprocessor/computer installed inside the battery system shell. The computer is connected to the sensors to detect the voltage, amperage, temperature, chemical parameters, usage history, the ID of the EVs, the ID of the recharge stations, . . . all the operational key data with time stamps. The data recorded are read-only by the computer in the vehicle and in the recharge station. The data can not be altered or erased by anyone or anyway, other than centralized and legally authorized means.
   As shown in FIG. 1 and FIG. 3, there are electric power connectors and onboard computer port connectors such as USB. These connectors will be engaged with the corresponding connectors onboard the EV or in the Recharge Station, when the SBA is inserted into the seated position in the standardized BC (Battery Compartment) in the EV or the Recharge Station.
   The connectors on each SBA can be redundantly designed and manufactured on one or both ends of the SBA. They (the connectors) also can be redundantly connected at one or both ends of the SBA when the BC door is closed. The redundancy can further increase the dependability of the system and reduce the electric resistance for the main battery power contacts. Symmetrical connectors on both ends can also eliminate the need to turn 180 degree when the SBA is exchanged between the EV and Recharge Station.
   The internal floor and side walls of the BC (either in EV or in the recharge station) can be equipped with rubber/elastomer rollers or antifriction Teflon coating to facilitate and guide the SBA during insertion and extraction (illustrated on FIG. 2 and FIG. 4). The rollers on the interior floor of the BC can be passive or powered. The rollers also serve as shock absorbers for the SBA to reduce vibration in a moving EV; and may serve as clamping mechanism to hold tight the SBA in the BC once the SBA is in the final seated position. The clamping action shall loosen up when insertion or extraction proceeds.
   The SBA may have its own ventilation/cooling/warming up system that will be turned on and off automatically when the needs arise for optimized operational condition for the batteries and the buried computer. Cooling fans are illustrated on the sample embodiment of the SBA.
   The BC door closing/opening actuator can be pneumatic, hydraulic, mechanical or electric with manual override (FIG. 4, FIG. 5 and FIG. 6). The door can be equipped or not equipped with rollers. As implied above, the back wall and the front door of the BC can be integrated with connectors matching those on the SBA, either on one side or on both sides of the SBA. In some designs on some of the EVs, the BC can be opened at either ends (two doors) to facilitate and expedite the insertion and extraction of the SBA.
   The IDs of the SBAs, the EVs and the Recharge Stations can all be represented by encrypted bar code labels or magnetic strip that can be read by the optical or magnetic readers installed on the vehicle or the station, besides communication through wireless or wired computer communication ports. The unique optical holographic encrypted bar code labels should be permanently manufactured on them, not to be changed, tampered, scraped, worn out, fade out, or lost; and should be tamper evident. All tampering efforts will be recorded and flagged, or even recorded in video.
   Privacy of the travel history of any EV by tracking the SBA exchange history stored either in the EV, the SBA or the Recharge Stations should be kept confidential by the system and system staff, and released only under a special and specific court warrant.
27. The Interior Composition of the Battery Exchange/Recharge Station Battery Recharge/Exchange stations are equipped with racks of BC (Battery compartments) arranged in stacks and arrays. Semiauomatic or manual transport systems are also feasible for beginner class low cost stations. For fully automated station, a 3D (Three Dimensional) conveyor system can be used to automatically transport the SBA to or from the vehicular exchange posts from or to a vacant BC in the station. The ID of the SBA and the address of the BC are stored in the station computer. The recharge process can be started as soon as the individual SBA is seated and all electric and electronic connections completed, and should follow the condition check/maintenance/recharge protocol and steps recommended by the manufacturer of the specific SBA.
   Examples for such Automated Storage and Retrieval Systems (ASRS) can be found in many websites and engineering textbooks, that indicate that the 3D Stacking system is a matured and feasible technology already in use and on the market. This invention is different from the ordinary ASRS in that it has connection and locking mechanisms for data interaction and power recharge pirposes. It could be an indispensable, integrated part of the advanced class of such subsystem in a EV system.
   The SBA will be fully recharged and maintained in the storage bin until there is an order to install the SBA to a waiting customer according to the customer's choice of battery grade. The rotation and dispatch of the SBAs of the same grade follow the ‘first come, first go’ principle, with manual over-ride.
   All the testing, maintenance and recharge history of the SBA will be stored in the datalogger of the SBA and in the station computer. Billing information will be sent to accounting headquarters from the station, very much like the credit card charge and billing system. Only for damages caused by negligence or accident happened in a specific EV that will be charged to that EV's owner's or its insurance company's account. All the regular wear and tear, recharge and other maintenance, and replenish of new battery assemblies will be paid by the system and thus will be distributed to all the customers according to the energy used and type of battery grade selected.
28. Forklift Embodiments for Beginning level Battery Exchange/Recharge Stations:
   For small or beginning level stations, instead of moving and arranging SBA by a full scale 3D conveyor system, the SBAs can be transported and stacked by fork lift with or without a driver, with different levels of modification (FIG. 8, FIG. 9, FIG. 10 and FIG. 11).
   Forklifts are used in some of the presently existing 3D ASRS with special modifications for special applications, but these are usually automated without a driver.
   The embodiments of Forklifts in FIG. 10 are equipped with sideway push and pull mechanisms so the forklift does not need to turn around to face the entrance of the battery compartment on the rack, and the width of the driving alley of forklift could be minimized. The sideway retrieval and delivering fork/platform can be designed to be bidirectional, i.e., able to pickup from or push the SBA to either left or right directions.
   Forklifts in the battery exchange/recharge stations are naturally electric powered by the same SBA as EVs serviced by the station. Though designed with human over-ride, the Forklifts for stacking the SBA are modified to be driven by computer controlled servo motors that will drive and stop at the exact position of the lane-column-level of the target BC (XYZ three dimensional address) in the station and align the receiving platform (fork) at the exact position of the exchange gates. All forklifts can be equipped with optical address readers to recognize the number/code of lane, the number/code of column and the number/code of level of the target compartment to match the 3D address for stacking and for pick up, that were sent from the office computer and shown on the forklift display screen or in audio signal.
   The forklift shown on FIG. 10 and FIG. 11 has its own storage compartments for reducing number of trips between the exchange gate and the recharge rack. A fully charged SBA can be stored on the forklift. When a used battery has to be put on the rack, a fully charged new battery can be immediately delivered from the temporary storage compartment, or picked up from the rack to be installed onto the waiting EV with no trip or only one trip for the forklift. In other situations, the forklift can transport several used or fully recharged SBA from the exchange gates to the storage rack in a single trip.
29. A automatic 3 D conveyor system with storage compartments for multitude of SBA that retrieves, stacks and inserts SBA to and from the computer designated BC addresses from and to the EVs at the service ports of RS. The Automatic 3D inventory stacking system is a matured technology, however, the 3D arrays of BC, each with locking mechanism and recharge and data communication ports are new patentable design.

What is claimed is:

1. A Electric Vehicle Design, Engineering, Manufacturing, Operation, and Management System, serving dual purpose as a part of Smart Energy Storage System (EV-SESS) for on-line network connected, and/or off-line storage for decentralized power generation, and/or emergency energy source for homes and other electricity users, that comprises of a multitude of integrated subsystems: a. the Electric Vehicle Subsystem (EV) operating on a rechargeable Smart Battery Assembly (SBA) carried in an onboard built-in battery compartment (BC); b. the SBA Subsystem; c. BC Subsystem; d. the SBA recharge/Swap/Maintenance/Management/Billing Station Subsystem (RS) distributed in the entire EV service territory; e. Computerized Management Subsystem (CMS) includes finance and billing management function.

2. EV as set forth in claim 1, is a vehicle powered by electricity stored in the SBA. The EV should be equipped with at least one BC onboard to contain SBA, also an accessory battery (AB) to power the electric devices, computer(s) except the propulsion motor(s) with and without the main SBA onboard the EV. The AB shall be recharged by the SBA, by plug in, by decentralized power sources. EV means any land, water, submerged or air vehicles, manned or unmanned.

3. SBA as set forth in claim 1, comprises of rechargeable storage batteries or other energy storage/production devices such as super-capacitor, flywheel batteries, fuel cells, micro-turbine, micro-hybrid power pack, etc. in a self-contained package of a standardized geometry; with embedded microprocessor/data-storage; with quick automatic connecting main electric connectors for charge/discharge, computer interface—wireless and/or connectors, that allows dependable connections when the SBA is inserted and seated to the predetermined position in the BC; with temperature control/cooling fans; that the construction, material and structure of the SBA shall be manufactured to facilitate and endure frequent insertion/retrieval/handling to and from between the BC of EV, the BC of RS, on the rollers, conveyor or specially designed material handling vehicle/lift, or onto or from a manual truck that allows small and home garage or roadside service to insert, retrieve, move and store the SBA. Multiple SBA's could be used in buses, trucks, vans, agricultural and construction vehicles and boats. The geometry, configuration, electric and electronic connectors, voltage, communication interface and protocol of the SBAs in the system should be made following standard specification for assured interchangeability. SBA shall have the option to have builtin charge controller and inverter, thus with both AC and DC connectors that match those on the BC. Extra SBAs could be used as online, offline energy storage means with centralized or decentralized recharge/discharge abilities and serving for emergency power supply means.

4. Battery Compartment (BC) as set forth in claim 1, is a box shaped device installed on the EV and RS, designed to contain, store, hold and connect the Discharge/Recharge electric poles (separate DC and AC poles) and communication ports on the SBA with those on the EV or RS. The. BC has powered or unpowered rollers/rail for facilitating insertion or retrieval of the heavy SBA to and from BC by either robotic mechanism or manual means; the elastomer lined rollers also serve as damping device to buffer road vibration. The BC has locking mechanism to ensure the correct and secure seating position of SBA and dependable connection of all the electric and electronic interface between SBA and EV, or SBS and RS, the locking mechanism may include sensors to signal the conveyor robotic system, the driver and the RS for final adjustment, and for signaling correct or erratic seating conditions.

5. A RS subsystem as set forth in claim 1, comprises of a multitude of RS stations distributed in the entire service territory (local, national and international) to provide SBA swapping, recharge, service, management and billing services. A RS has a multitude of battery swapping ports leading from the entrance driveway from a street. Each battery swapping port is equipped with a movable reception ramp with powered or nonpowered rollers to aim to the exit door of the BC on the EV. RS also is equipped with 3D stack of BCs with manual, semiautomatic or automatic transport/stacking means to move SBAs to and from the BC of the EVs from and to the computer designated BC slot address in the 3D stack. The BCs in the RS have the receptacles and ports for electric and electronic connection to the stored SBA, and positioning and locking mechanism and signal sensors, similar to those in the BC of the EV, to assure dependable physical, electric and electronic positioning and connections between the SBA and BC. The RS computer should retrieve and monitor the data on all the SBAs in the BC slots to determine the suitable recharge, maintenance processes and status, the readiness to be inserted to a customer EV, or to be discarded and replaced. The data exchange between the SBA and RS should include but not limited to the date and time stamps, the IDs of the EV and SBAs being served, the technical condition and discharge/recharge history of the SBA, the energy left in the SBA, the recharge process, etc. for billing, maintenance, and management purposes. The RS will be supplied with recharge electricity by the electric power network or distributed power generation facilities and serving as part of the smart network—a district bank of electricity depository to buffer the network loading fluctuation by feeding back some energy back to the network, or in emergency, when needed.

6. Computerized Management Subsystem (CMS) as set forth in claim 1, includes software and hardware, for finance, billing and management functions, that connects all the computers in the RS and those in the headquarters of the EV-SESS with high speed IT connection network.
The CMS is equivalent to the central nervous system in a highly functioning organism—an indispensable subsystem of the entire EV-SESS. The computers in each of the RS have interfacing/communication capabilities with the EVs at the service ports and the SBAs in the BCs at the BC stacks and the SBA stacking/transportation carriers.
